(19) United States
(12) Patent Application Publication
(10) Pub. No.: US 2004/0221495 A1
(43) Pub. Date: Nov. 11, 2004

(54) Whirling device

(76) Inventor: Per M. Hogestad, Fort Collins, CO (US)

Correspondence Address: ANCEL W. LEWIS, JR., 425 WEST MULBERRY, SUITE 101, FORT COLLINS, CO, 80521, US

(21) Appl. No.: 10/430,799

(22) Filed: May 6, 2003

(51) Int. Cl. G09F 19/08

(52) U.S. Cl. 40/421

(57) ABSTRACT

A whirling device has a hollow, aerodynamic body that pivots on a vertical rod, and a rotary wheel that mounts in and projects from the body. The wheel has hub and blades that extend outward from the hub. The body pivots in response to air flow to align the with the air flow while the blades whirl the rotary wheel in response to the air flow. Artwork on the body and rotary wheel simulates animation when the rotary wheel whirls. The body and rotary wheel are each made from flat blanks of thin sheet material.

### TECHNICAL FIELD

This invention relates to whirling devices and more particularly a novel air driven whirling device.

### BACKGROUND ART

A number of attempts have heretofore been made to provide air driven whirling devices that respond to air flow. Some of these devices are supported by a stationary support and others are moved relative to the ground so that a rotating whirling wheel or propeller portion rotates in response to air current.

U.S. Pat. No. 1,930,164 to Fletcher, U.S. Pat. No. 1,953,272 to Smith, U.S. Pat. No. 1,954,721 to Whitlow, U.S. Pat. No. 2,069,110 to Naus, U.S. Pat. No. 2,573,625 to Swart, U.S. Pat. No. 2,701,928 to Keenan et al., U.S. Pat. No. 2,810,223 to Fraesdorf, Jr., U.S. Pat. No. 2,817,913 to Meyer, and U.S. Pat. No. 4,656,768 to Thigpen disclose wind driven display devices or signs. U.S. Pat. No. 3,172,220 to Christensen discloses a device that mounts on the top of an automobile antenna. U.S. Pat. No. 4,546,562 to Jones discloses an air driven animated toy.

### DISCLOSURE Of THE INVENTION

An aerial device adapted to mount on a stationary support or a moving support, such as an antenna on a vehicle, has an aerodynamic body of thin sheet material supporting a whirling wheel or propeller that rotates relative to the body in response to air currents. The embodiment shown has both the body and rotary wheel made from a flat blank of sheet material such as cardboard and can be bent along fold lines, secured to form the body and be readily assembled. The form shown is particularly suited to mount on the antenna of a vehicle, and an illustrative form has indicia and artwork showing two football players.

### BRIEF DESCRIPTION OF THE DRAWINGS

Details of this invention are described in connection with the accompanying drawings that bear similar reference numerals in which:

FIG. 1 is a perspective view of a whirling device embodying features of the present invention.

FIG. 2 is a perspective view of the whirling device of FIG. 1 with dashed lines showing internal parts.

FIG. 3 is an enlarged plan view of the hub of the rotary wheel of the whirling device of FIG. 1.

FIG. 4 is a plan view of the flat blank for the aerodynamic body of the whirling device of FIG. 1.

FIG. 5 is a plan view of the flat blank for the rotary wheel of the whirling device of FIG. 1.

FIG. 6 is a side elevation view of the whirling device of FIG. 1 with artwork and indicia.

FIG. 7 is a side elevation view of the whirling device of FIG. 1 mounted in an inverted position.

FIG. 8 is a side elevation view of the whirling device of FIG. 1 mounted in a first side position.

FIG. 9 is a side elevation view of the whirling device of FIG. 1 mounted in a second side position.

### DETAILED DESCRIPTION OF THE INVENTION

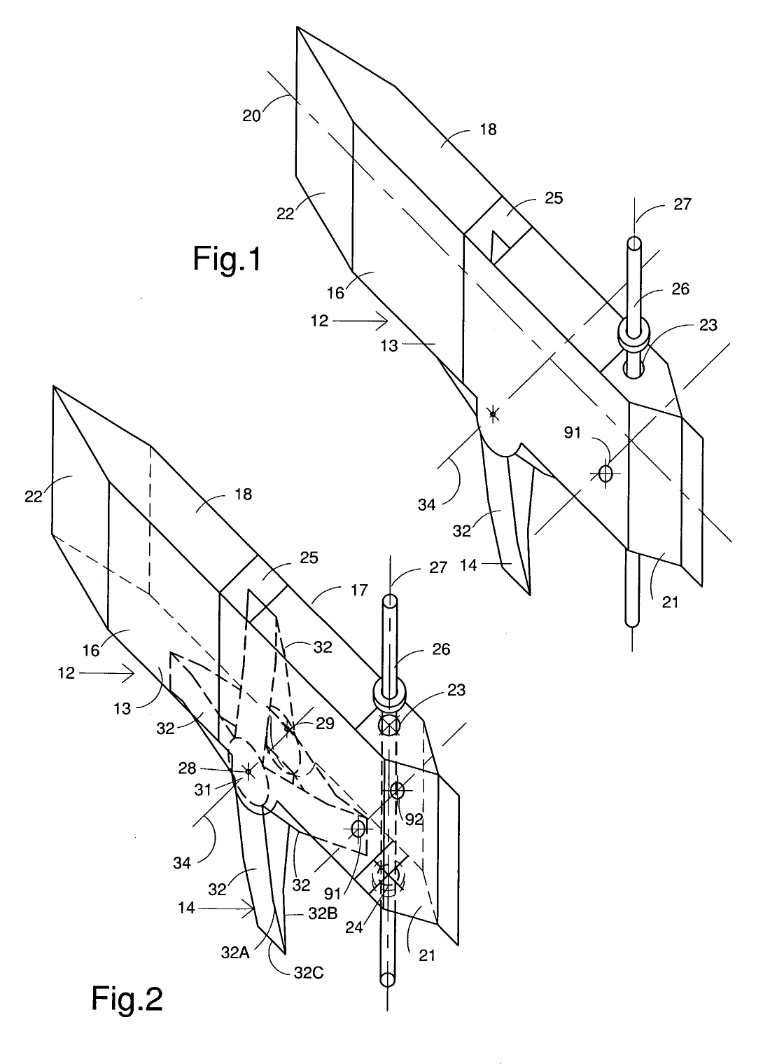

Referring now to FIGS. 1 and 2, a whirling device 12, includes a hollow thin-walled aerodynamic body 13 and a rotary propeller or wheel 14 supported by the body 13. The body 13 has spaced, substantially parallel first and second walls 16 and 17, and spaced third and fourth walls 18 and 19 that extend between and connect the first and second walls 16 and 17 along opposite edges. The first and second walls 16 and 17 bend inward and converge at one end to form a pointed front end 21 of the body 13, and bend inward and converge at the opposite end to form a pointed rear end 22 of the body 13. A longitudinal axis 20 extends from the front end 21 to the rear end 22.

Aligned, round first and second body apertures 23 and 24 are provided in forward portions of the third and fourth walls 18, respectively. The first and second body apertures 23 and 24 are sized to receive a vertical rod 26 to support the body 13 for rotation about a vertical axis 27. The body 13 is shaped such that air flow along the body 13 rotates the body 13 to align the longitudinal axis 20 with the direction of air flow. Round first and second wheel apertures 28 and 29 are provided in lower portions of the first and second walls 16 and 17, respectively, intermediate the front and rear ends 21 and 22, to support the rotary wheel 14, as described hereinafter. A substantially rectangular wheel opening 30 in the fourth wall 19 allows the rotary wheel 14 to be inserted into the body 13 with a portion of the rotary wheel 14 projecting beyond the body 13. The third wall 18 includes a centrally disposed hole 25.

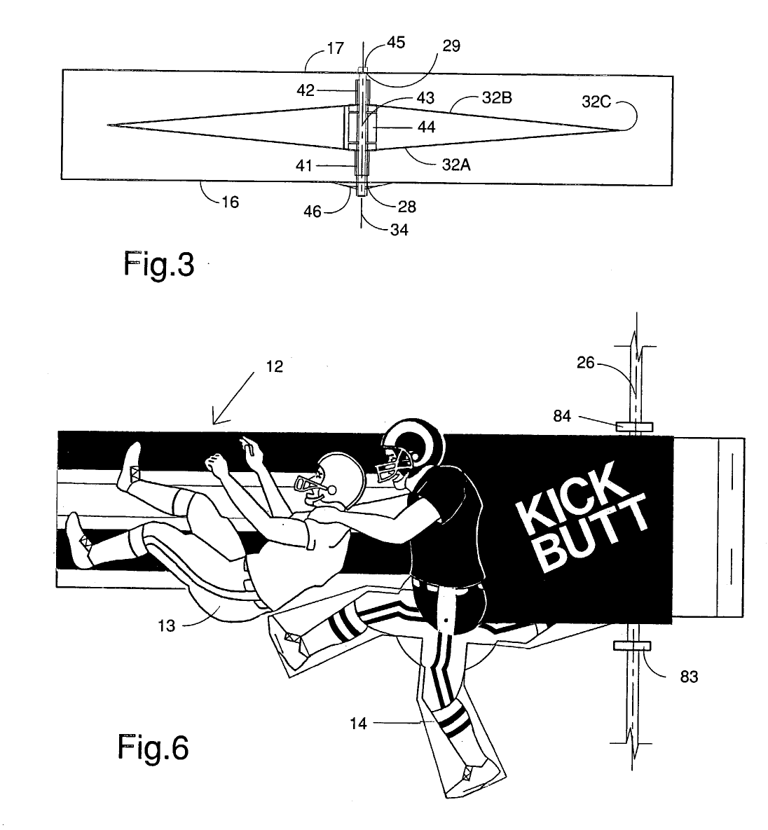

The rotary wheel 14 shown includes a hub 31 and four equally spaced radially extending blades 32 as viewed from the side. The hub includes spaced hub sections 31A and 31B, each having a centrally disposed hub aperture 33. Each blade 32 has two axially spaced blades sections 32A and 32B that extend from the hub sections 31A and 31B, respectively, and that converge to a point 32C at the circumference, so as to be V-shaped as viewed from the end. Referring to FIG. 3, opposed first and second T-bushings 41 and 42 insert into the hub apertures 33. A bushing spacer 44 engages the head of the T-bushings to hold the hub sections 31A and 31B a fixed distance apart at the hub 31. An axle 43 extends through the first wheel aperture 28, the first T-bushing 41, the bushing spacer 44, the second T-bushing 42 and the second wheel aperture 29, with the rotary wheel 14, the first and second T-bushings 41 and 42 and the bushing spacer 44 rotating together freely on the axle 43. The axle 43 has a head 45 at one end and a speed nut 46 on the opposite end to secure the axle 43 to the body 13. The first and second wheel apertures 28 and 29 are aligned along a wheel axis 34, about which rotary wheel 14 rotates, that is substantially perpendicular to the longitudinal axis 20.

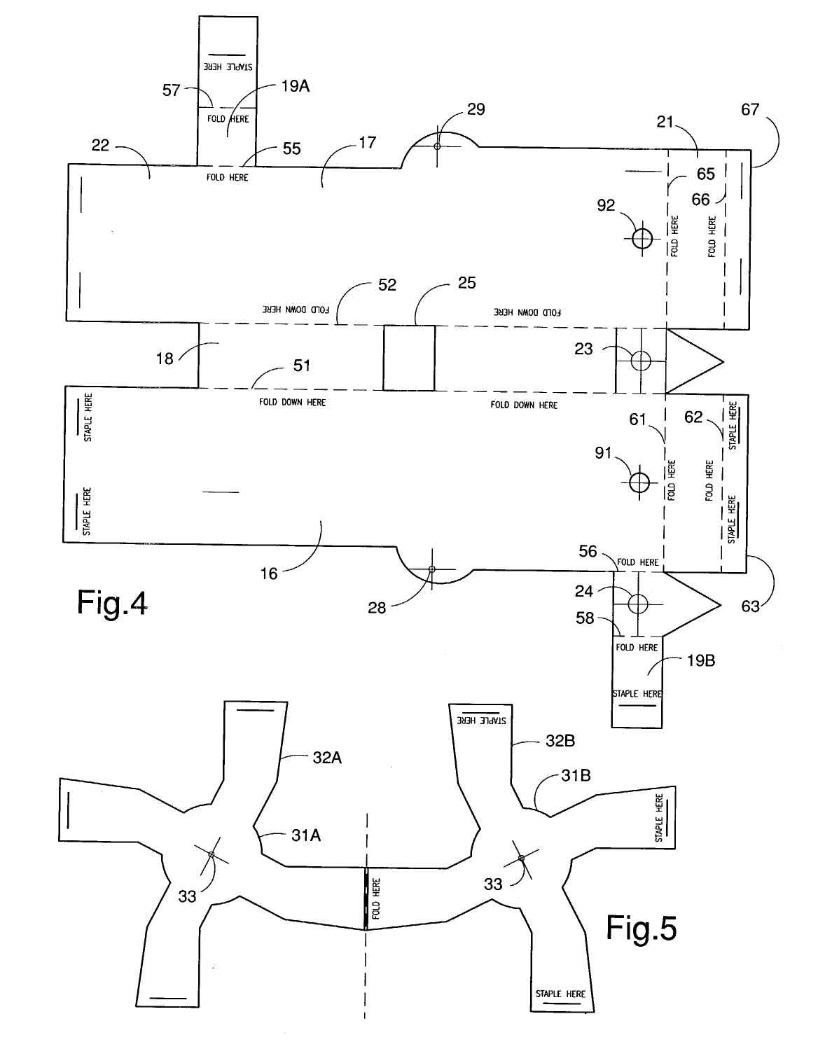

Referring to FIG. 4, the body 13 shown is made of a flat body blank 50, preferably cardboard. The first wall 16 connects to the third wall 18 along a first primary fold line 51 of the body blank 50, and the second wall 17 connects to the third wall 18 along a spaced, parallel second primary fold line 52 of the body blank 50, so that when the body blank 50 is folded along the first and second fold lines 51 and 52, a portion of the body 13 is formed, with the first and second fold lines 51 and 52 at two corners. The fourth wall 19 includes first and second wall sections 19A and 19B. The first wall section 19A connects to the second wall 17 at a first section fold line 55 at the rear of the body 50. The second wall section 19B is connected to the first wall 16 at a second section fold line 56 at the front of the body 50. The first wall section 19A has a third section fold line 57 spaced from the first section fold line 55 so that when the body blank 50 is folded along the first and third section fold lines 55 and 57, the end portion beyond third section fold line 57 will attach to the first wall 16 as by a staple or adhesive. Similarly the second wall section 19B has a fourth section fold line 58 spaced from the second section fold line 56 so that when the body blank 50 is folded along the second and fourth section fold lines 56 and 58, the end portion beyond fourth section fold line 58 will attach to second wall 17 as by a staple or adhesive. The first and second wall sections 19A and 19B of the fourth wall 19 define the opening 30 through which the rotary wheel 14 extends.

The first wall 16 has a first end fold line 61 along the front and a second end fold line 62 closer to the first front edge 63. Similarly, the second wall 17 has a third end fold line 65 and a fourth fold line 66 closer to the second front edge 67. When folded along these fold lines the forwardly converging front end 21 is formed. The portions between second and fourth end fold lines 62 and 66 and front edges 63 and 67 abut one another and can be fastened by staples or an adhesive. The rear end portion of the first wall 16 and second wall 17 butt against one another and may be fastened by staples or adhesive to form the rearwardly converging rear end 22. It is understood the above described body can be formed in a variety of ways including being a molded plastic body.

Referring to FIG. 5, the rotary wheel 14 shown is made from a flat wheel blank 72, preferably of cardboard, that is in the shape of two star shaped sections making up hub sections 31A and 31B and blade sections 32A and 32B that are mirror images as viewed from the side and are connected end to end along a wheel fold line 73. When the wheel blank 72 is folded along the wheel fold line 73, the hub sections 31A and 31B of the rotary wheel 14 and two axially spaced hub sections 31 and 32 are formed. The circumferential end portions the blades are shown fastened by staples or an adhesive could be used.

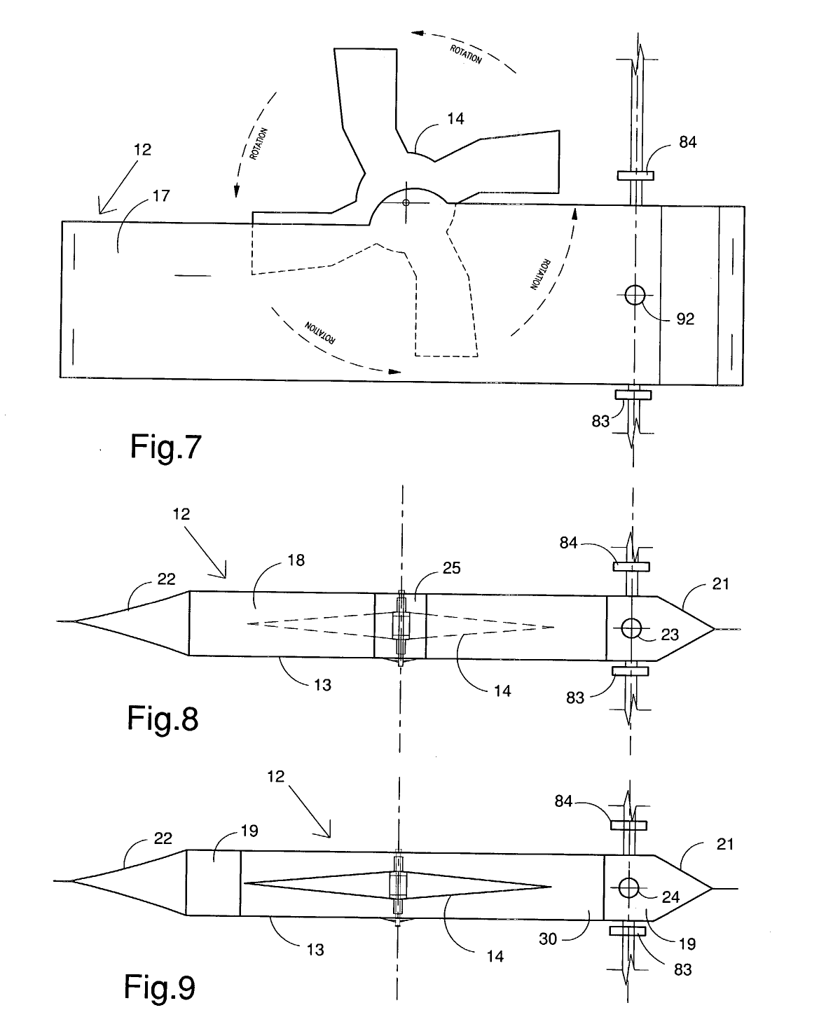

The whirling device 12 will operate with the wheel axis 34 horizontal as shown in FIG. 6 and in an inverted position as shown in FIG. 7. Further opposed third and fourth body apertures 91 and 92 may be provided in a front portion of the first and second walls 16 and 17, respectively, so the whirling device 12 may operate when turned on either side with the wheel axis 34 vertical, as shown in FIGS. 8 and 9.

Referring again to FIG. 6, the whirling device 12 shown is mounted on the vertical rod 26 such as a vehicle antenna by inserting a bottom stop collar 83 on the antenna and sliding the body 13 down on the rod 26 via the first and second body apertures 23 and 24. A top stop collar 84 is provided above the body 13. Air flow about the whirling device 12 pivots the body 13 about the rod 26 to point the front end 21 into the air flow while air flow striking the front edge of the blades 32 causes the rotary wheel 14 to rotate. The whirling device 12 may have indicia and artwork simulating animation, such as artwork illustrating a human body portion on the body 13 and artwork illustrating a limb on each blade 32 so that the whirling blades 32 simulate moving limbs. As an example, and not a limitation, FIG. 6 shows two football players with the rotating blades 32 depicting the leg of one football player striking the behind of the other football player as the rotary wheel 14 rotates in response to air currents.

Although the present invention has been described with a certain degree of particularity, it is understood that the present disclosure has been made by way of example and that changes in details of structure may be made without departing from the spirit thereof.

What is claimed is:

1. A whirling device comprising:
a hollow body having a front end and a rear end with a longitudinal axis extending there between, said body being adapted to pivotally mount on a vertical rod with a vertical axis and shaped to pivot about said vertical axis in response to air flow about said body to align said longitudinal axis with the direction of said air flow, said body having a wheel opening between said front and rear ends, and
a rotary wheel rotably mounted in said rotary wheel opening about a wheel axis that is substantially perpendicular to said longitudinal axis, said rotary wheel having a hub and a plurality of spaced, radially extending blades from said hub with at least one said blade extending beyond said body, whereby said rotary wheel whirls in response to said air flow.

2. The whirling device as set forth in claim 1 wherein said wheel axis is horizontal.

3. The whirling device as set forth in claim 1 wherein said wheel axis is vertical.

4. The whirling device as set forth in claim 1 wherein said body is adapted to mount on said rod with said wheel axis horizontal, adapted to mount on said rod with said wheel axis vertical, and adapted to mount on said rod inverted.

5. The whirling device as set forth in claim 1 wherein said body has spaced, substantially parallel first and second walls that converge at one end to form said front end of said body and converge at an opposite end to form said rear end of said body, and spaced third and fourth walls that extend between and connect said first and second walls along opposite edges of said first and second walls,
said fourth wall has said wheel opening, and
said third and fourth walls have aligned, round first and second body apertures, respectively, near said front end of said body, sized to receive said rod to pivotally mount said body on said rod.

6. The whirling device as set forth in claim 5 including a bottom stop collar adapted to mount on said rod below said body and a top stop collar adapted to mount on said rod above said body.

7. The whirling device as set forth in claim 5 wherein first and second walls have aligned, round third and fourth body apertures, respectively, near said front end of said body, sized to receive said rod to provide an additional position to pivotally mount said body on said rod.

8. The whirling device as set forth in claim 1 wherein said body is made from a flat body blank of thin sheet material that is folded along a plurality of body fold lines to form said body.

9. The whirling device as set forth in claim 1 wherein said rotary wheel is made from a flat wheel blank of thin sheet material that has two star shaped sections that are connected along a wheel fold line with the wheel blank being folded along said wheel fold line to form said wheel.

10. The whirling device as set forth in claim 1 wherein said hub includes two spaced hub sections and each said blade includes two blade sections with one said blade section extending radially from each said hub section, and said blade sections converging to a point at the circumference.

11. The whirling device as set forth in claim 1 wherein said body and said rotary wheel include artwork that simulates animation when said rotary wheel rotates.

12. The whirling device as set forth in claim 11 wherein said artwork depicts two football players with said rotating blades depicting the leg of one football player striking the behind of the other football player as said rotary wheel rotates in response to said air flow.

13. A whirling device comprising:
a hollow body, made from a flat body blank of thin sheet material that is folded along a plurality of body fold lines to form said body, having a front end and a rear end with a longitudinal axis extending therebetween, said body having spaced, substantially parallel first and second walls that converge at one end to form said front end of said body and converge at an opposite end to form said rear end of said body, and spaced third and fourth walls that extend between and connect said first and second walls along opposite edges of said first and second walls, said third and fourth walls having aligned, round first and second body apertures, respectively, near said front end of said body, sized to receive a vertical rod with a vertical axis to pivotally mount said body on said rod, said first and second walls having aligned, round third and fourth body apertures, respectively, near said front end of said body, sized to receive said rod to provide an additional position to pivotally mount said body on said rod, said body being shaped to pivot about said vertical axis in response to air flow about said body to align said longitudinal axis with the direction of said air flow, said fourth wall having a wheel opening between said front and rear ends, said body having artwork,
a bottom stop collar adapted to mount on said rod below said body and a top stop collar adapted to mount on said rod above said body, and
a rotary wheel, made from a flat wheel blank of thin sheet material that has two star shaped sections that are connected along a wheel fold line with the wheel blank being folded along said wheel fold line to form said rotary wheel, rotably mounted in said wheel opening about a wheel axis that is substantially perpendicular to said longitudinal axis, said rotary wheel having a hub and a plurality of spaced, radially extending blades from said hub with at least one said blade extending beyond said body, said hub having two spaced hub sections and each said blade includes two blade sections with one said blade section extending radially from each said hub section, and said blade sections converging to a point at the circumference, said rotary wheel having artwork, whereby said rotary wheel whirls in response to said air flow and said artwork on said rotary wheel simulates animation.
